(19) United States
(12) Patent Application Publication
(10) Pub. No.: US 2021/0065071 A1
(43) Pub. Date: Mar. 4, 2021

(54) STATE SPACE MODEL DERIVING SYSTEM, METHOD AND PROGRAM

(71) Applicant: NEC CORPORATION, Tokyo (JP)

(72) Inventor: Riki ETO, Tokyo (JP)

(73) Assignee: NEC CORPORATION, Tokyo (JP)

(21) Appl. No.: 16/962,253

(22) PCT Filed: Jan. 18, 2018
(86) PCT No.: PCT/JP2018/001398

§ 371 Date: Jul. 15, 2020

(51) Int. Cl. G06Q 10/02; G06F 17/18; G06N 20/00

(52) U.S. Cl. CPC G06Q 10/02; G06N 20/00; G06F 17/18

(57) ABSTRACT

The learning unit 3 learns a regression equation based on learning data. The learning data includes a value for a state in a state space model at each time. Also, the learning data includes a set of combinations of a certain time, a value for the state at each of times from a time one time before the certain time to a time n times (n is an integer of 2 or more) before the certain time, a value for an input in the state space model at the certain time obtained one time before the certain time, and a value or values for one or more attributes at the certain time obtained one time before the certain time. The learning unit 3 learns a regression equation using the state at a future time as an objective variable and including, as explanatory variables, at least, explanatory variables each representing the state at each of times from a time one time before the future time to a time m times (m is an integer of 1 or more and n or less) before the future time and an explanatory variable representing the input at the future time obtained one time before the future time. A conversion unit 4 converts the regression equation to have a form of the state space model.

### TECHNICAL FIELD

The present invention relates to a state space model deriving system deriving a state space model based on learning data, a state space model deriving method, and a state space model deriving program.

### BACKGROUND ART

PTL 1 describes a linear parameter varying model estimating system estimating a linear parameter varying model of a physical system.

Also, PTL 2 describes that a process is approximated by an autoregressive moving average model having a predetermined structure.

### CITATION LIST

### Patent Literature

PTL 1: International Publication No. 2016/194025

PTL 2: Japanese Patent Application Laid-Open No. 7-295604

### SUMMARY OF INVENTION

### Technical Problem

As an example of a model for predicting a future state, a state space model is raised. The state space model does not always have controllability. Here, the controllability means that, when an arbitrary initial state and a target state are given, the initial state can move to the target state.

As described above, the state space model does not always have controllability. Therefore, in a case in which a state is predicted by a state space model having no controllability, the state can be predicted, but the predicted state cannot be set to a desired value. For example, suppose that a state space model in which the number of reservations for an accommodation facility is a state is obtained, and that the state space model does not have controllability. In this case, the number of future reservations (state) predicted by the state space model may exceed an upper limit of the number of reservations for the accommodation facility. However, it is not possible to set the predicted number of future reservations to a desired value less than the upper limit.

An object of the present invention is to provide a state space model deriving system enabling a state space model having controllability to be derived, a state space model deriving method, and a state space model deriving program.

### Solution to Problem

A state space model deriving system according to the present invention includes a learning unit, based on a value for a state in a state space model at each time, and a set of combinations of a certain time, a value for the state at each of times from a time one time before the certain time to a time n times (n is an integer of 2 or more) before the certain time, a value for an input in the state space model at the certain time obtained one time before the certain time, and a value or values for one or more attributes at the certain time obtained one time before the certain time, learning a regression equation using the state at a future time as an objective variable and including, as explanatory variables, at least, explanatory variables each representing the state at each of times from a time one time before the future time to a time m times (m is an integer of 1 or more and n or less) before the future time and an explanatory variable representing the input at the future time obtained one time before the future time, and a conversion unit converting the regression equation to have a form of the state space model.

Also, a state space model deriving method according to the present invention includes, based on a value for a state in a state space model at each time, and a set of combinations of a certain time, a value for the state at each of times from a time one time before the certain time to a time n times (n is an integer of 2 or more) before the certain time, a value for an input in the state space model at the certain time obtained one time before the certain time, and a value or values for one or more attributes at the certain time obtained one time before the certain time, learning a regression equation using the state at a future time as an objective variable and including, as explanatory variables, at least, explanatory variables each representing the state at each of times from a time one time before the future time to a time m times (m is an integer of 1 or more and n or less) before the future time and an explanatory variable representing the input at the future time obtained one time before the future time, and converting the regression equation to have a form of the state space model.

Also, a state space model deriving program causes a computer to execute, based on a value for a state in a state space model at each time, and a set of combinations of a certain time, a value for the state at each of times from a time one time before the certain time to a time n times (n is an integer of 2 or more) before the certain time, a value for an input in the state space model at the certain time obtained one time before the certain time, and a value or values for one or more attributes at the certain time obtained one time before the certain time, learning processing of learning a regression equation using the state at a future time as an objective variable and including, as explanatory variables, at least, explanatory variables each representing the state at each of times from a time one time before the future time to a time m times (m is an integer of 1 or more and n or less) before the future time and an explanatory variable representing the input at the future time obtained one time before the future time, and conversion processing of converting the regression equation to have a form of the state space model.

### Advantageous Effects of Invention

According to the present invention, a state space model having controllability can be derived.

### BRIEF DESCRIPTION OF DRAWINGS

FIG. 1 It depicts a block diagram illustrating an example of a state space model deriving system according to the present invention.

FIG. 2 It depicts a schematic view illustrating an example of a first tabular data.

FIG. 3 It depicts a schematic view illustrating an example of a second tabular data.

FIG. 4 It depicts a schematic view illustrating an example of a third tabular data.

FIG. 5 It depicts a flowchart illustrating an example of a processing procedure of the state space model deriving system.

FIG. 6 It depicts a schematic block diagram illustrating a configuration example of a computer according to an exemplary embodiment of the present invention.

FIG. 7 It depicts a block diagram illustrating an overview of the state space model deriving system according to the present invention.

### DESCRIPTION OF EMBODIMENTS

Hereinbelow, exemplary embodiments of the present invention will be described with reference to the drawings.

In the present invention, a “time” is a unit of time having a time width.

In the following description, a case of using each day as an example of each time will be described. For example, in a case in which a certain time t is October 10, a time one time before the time t is October 9 and a time after the time t is October 11.

However, in the present invention, how to set the time is not limited to the above example. For example, a time after a certain time may be set to be a day two days after the day corresponding to the certain time. In this example, in a case in which a certain time t is Octobe 10, a time one time before the time t is October 8 and a time after the time t is October 12.

As described above, in the following description, the case of using each day as an example of each time will be described.

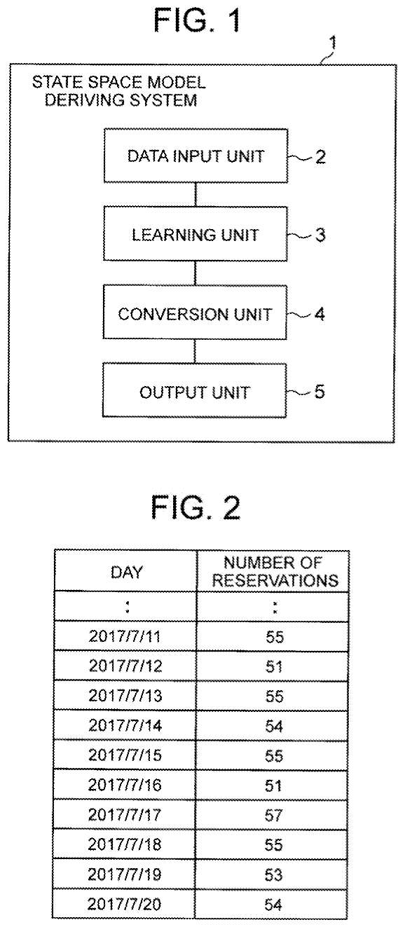

FIG. 1 depicts a block diagram illustrating an example of a state space model deriving system according to the present invention. A state space model deriving system 1 according to the present invention includes a data input unit 2, a learning unit 3, a conversion unit 4, and an output unit 5.

The state space model deriving system 1 according to the present invention derives a state space model having controllability. Also, in the present exemplary embodiment, a “state” in a state space model derived by the state space model deriving system 1 is the number of reservations of guest rooms for a facility (here, an accommodation facility A), and an “input” in the state space model is a price for using the accommodation facility A. Also, a price at a certain time is determined one time before the time. In the present exemplary embodiment, since each day corresponds to each time, the price on a certain day is determined one day before the day.

The data input unit 2 receives data input via, for example, a data reading device that reads input data 11 stored in a data recording medium such as an optical disk. The data input into the data input unit 2 is data corresponding to learning data for learning a below-mentioned linear regression equation and data that is a base for the learning data.

The data input unit 2 also generates learning data based on the input data.

In the present exemplary embodiment, a case in which two pieces of tabular data are input into the data input unit 2 will be described as an example. FIG. 2 depicts a schematic view illustrating an example of first tabular data (hereinbelow referred to as first tabular data) input into the data input unit 2. The first tabular data illustrated in FIG. 2 indicates an actual value for the number of reservations of guest rooms for the accommodation facility A (“state” in the state space model) on each day in the past. The example illustrated in FIG. 2 indicates that the actual value for the number of reservations on Jul. 11, 2017 is “55”, for example.

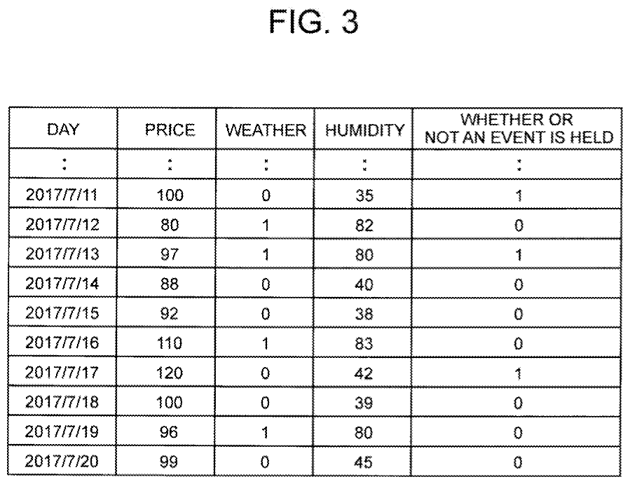

FIG. 3 depicts a schematic view illustrating an example of second tabular data (hereinbelow referred to as second tabular data) input into the data input unit 2. In the second tabular data illustrated in FIG. 3, a past day, a value for a price (“input” in the state space model), a value for an attribute “weather”, a value for an attribute “humidity”, and a value for an attribute “whether or not an event is held” are associated. However, the values for “price”, “weather”, “humidity”, and “whether or not an event is held” are values determined or obtained by a weather forecast and the like one day before the day associated with the values and are not actual values on the day associated with the values.

Meanwhile, in the present example, the value for the attribute “weather” is “1” in a case in which it is predicted to be rainy and “0” in a case in which the weather other than rain is predicted. Also, the value for the attribute “humidity” is a predicted value for humidity. Also, the value for the attribute “whether or not an event is held” is “1” in a case in which an event is held in the vicinity of the accommodation facility A and “0” in a case in which no event is held in the vicinity of the accommodation facility A.

For example, in FIG. 3, each value associated with “Jul. 20, 2017” represents the following. The value for “price” associated with “Jul. 20, 2017” represents an accommodation price for the accommodation facility A on “Jul. 20, 2017” determined one day before (Jul. 19, 2017) “Jul. 20, 2017”. Also, the values for “weather” and “humidity” associated with “Jul. 20, 2017” represent a forecast value for whether or not it is rainy and a forecast value for humidity on “Jul. 20, 2017” obtained by a weather forecast and the like one day before (Jul. 19, 2017) “Jul. 20, 2017”. Also, the value for “whether or not an event is held” associated with “Jul. 20, 2017” represents a value indicating whether or not an event is held on “Jul. 20, 2017” obtained one day before (Jul. 19, 2017) “Jul. 20, 2017”.

The values for “price”, “weather”, “humidity”, and “whether or not an event is held” associated with each day other than “Jul. 20, 2017” are also values determined or obtained one day before the day associated with the values.

Meanwhile, in the present exemplary embodiment, description will be provided by using “weather”, “humidity”, and “whether or not an event is held” as the attributes other than “state” and “input”, and the attributes other than “state” and “input” are not limited to “weather”, “humidity”, and “whether or not an event is held”.

Also, the data input unit 2 generates learning data for learning a linear regression equation based on the first tabular data and the second tabular data.

The data input unit 2 uses the first tabular data as it is as a part of the learning data.

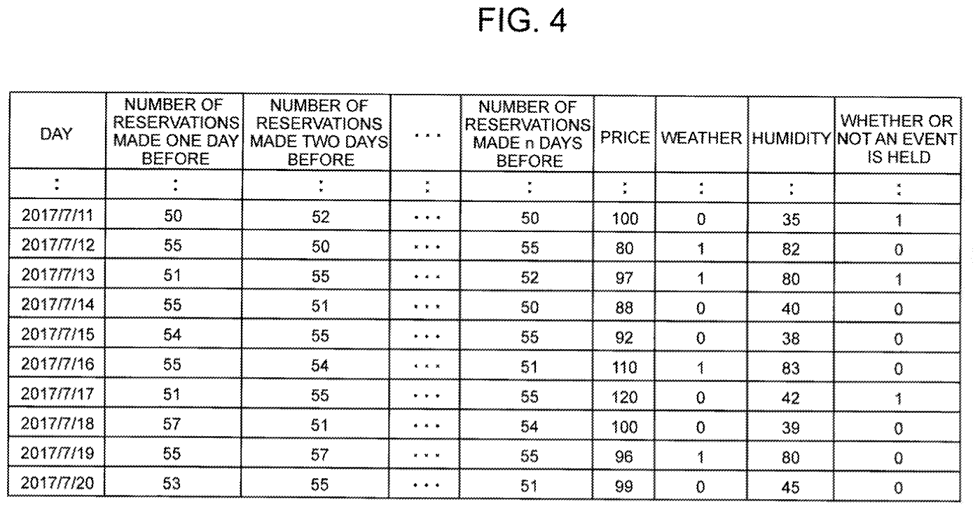

Also, n is an integer of 2 or more. The data input unit 2 adds to each row of the second tabular data a value for the number of reservations on each of days from a day one day before the day provided at the left end to a day n days before the day provided at the left end. Tabular data obtained as a result of this is referred to as third tabular data. FIG. 4 depicts a schematic view illustrating an example of the third tabular data.

“Number of reservations made one day before”, “number of reservations made two days before”, . . . , and “number of reservations made n days before” the day provided at the left end illustrated in FIG. 4 are actual values for the numbers of reservations extracted from the first tabular data. For example, the data input unit 2 may extract the number of reservations “53” on “Jul. 19, 2017” from the first tabular data as “number of reservations made one day before” “Jul. 20, 2017” and add the number to the row of “Jul. 20, 2017” as illustrated in FIG. 4. Also, for example, the data input unit 2 may extract the number of reservations “55” on “Jul. 18, 2017” from the first tabular data as “number of reservations made two days before” “Jul. 20, 2017” and add the number to the row of “Jul. 20, 2017” as illustrated in FIG. 4. Similarly, the data input unit 2 extracts the numbers up to “number of reservations made n days before” “Jul. 20, 2017” from the first tabular data and adds the numbers to the row of “Jul. 20, 2017”. For the other rows, the data input unit 2 may extract “number of reservations made one day before” to “number of reservations made n days before” from the first tabular data and add the numbers to a row of interest.

The values for “price”, “weather”, “humidity”, and “whether or not an event is held” in the third tabular data (refer to FIG. 4) are equal to the values for “price”, “weather”, “humidity”, and “whether or not an event is held” in the second tabular data (refer to FIG. 3).

In the third tabular data, “number of reservations” corresponds to a state in the state space model, and “price” corresponds to an input in the state space model. “Weather”, “humidity” and “whether or not an event is held” are merely attributes. How to define the state, the input, and the attributes in the state space model is not limited to the example illustrated in the present exemplary embodiment.

The first tabular data (refer to FIG. 2) and the third tabular data (refer to FIG. 4) are learning data.

Meanwhile, the first tabular data indicates a value for the state (number of reservations) in the state space model at each time (each day). Also, it can be said that the first tabular data is a set of combinations of the time (the day in the present exemplary embodiment) provided at the left end of each row and the state (the number of reservations) on the day provided at the left end of the row.

Also, it can be said that the third tabular data (refer to FIG. 4) is a set of combinations of the time (the day in the present exemplary embodiment) provided at the left end of each row, the value for the state (the number of reservations) on each of the days from the day one day before the day provided at the left end of the row to the day n days before the day provided at the left end of the row, the input (price) on the day provided at the left end of the row obtained one day before the day provided at the left end of the row, and the value or values for one or more attributes on the day provided at the left end of the row obtained one day before the day provided at the left end of the row. One row illustrated in FIG. 4 corresponds to one combination.

The data input unit 2 inputs learning data (the first tabular data (refer to FIG. 2) and the third tabular data (refer to FIG. 4)) to the learning unit 3.

The learning unit 3 learns based on learning data a linear regression equation using a state at a future time as an objective variable and including, as explanatory variables, at least, explanatory variables each representing the state at each of times from a time one time before the future time to a time m times before the future time and an explanatory variable representing an input at the future time obtained one time before the future time. Here, the future time is a time subsequent to a current time. In the present exemplary embodiment, the future time is a day after a day corresponding to a current day, and this day is referred to as a prediction target day.

In other words, in the present exemplary embodiment, the learning unit 3 learns based on learning data a linear regression equation using a state (number of reservations) on a prediction target day as an objective variable and including, as explanatory variables, at least explanatory variables each representing the state (number of reservations) on each of days from a day one day before the prediction target day to a day m days before the prediction target day and an explanatory variable representing an input (price) on the prediction target day determined one day before the prediction target day.

Here, m is an integer of 1 or more and n or less. As described above, n is an integer of 2 or more.

Specifically, the learning unit 3 learns a linear regression equation expressed in the form of Equation (1) provided below based on the learning data.

yₖ₊₁=a₁yₖ+a₂yₖ₋₁+ . . . +aₘyₖ₋ₘ₊₁+buₖ+rₖ (1)

yₖ₊₁ is an objective variable representing the number of reservations on the prediction target day.

yₖ, yₖ₋₁, . . . , and yₖ₋ₘ₊₁ are an explanatory variable representing the number of reservations made one day before the prediction target day, an explanatory variable representing the number of reservations made two days before the prediction target day, . . . , and an explanatory variable representing the number of reservations made m days before the prediction target day, respectively. a₁ to aₘ are coefficients of these explanatory variables.

Also, uₖ is an explanatory variable representing an input (price) on the prediction target day determined one day before the prediction target day. b is a coefficient of the explanatory variable uₖ.

rₖ is a function including explanatory variables corresponding to attributes other than “state” and “input”. For example, rₖ is expressed as Equation (2) provided below.

rₖ=c₁X₁+c₂X₂+C (2)

In Equation (2), X₁ is, for example, an explanatory variable corresponding to “weather” illustrated in FIG. 4, and c₁ is a coefficient of the explanatory variable X₁. Also, X₂ is, for example, an explanatory variable corresponding to “whether or not an event is held” illustrated in FIG. 4, and c₂ is a coefficient of the explanatory variable X₂. C is a constant term.

In the above example, an explanatory variable corresponding to “humidity” illustrated in FIG. 4 is not included in rₖ (Equation (2)). In this manner, the learning unit 3 may select an attribute to be included as an explanatory variable in the linear regression equation from among attributes other than “state” and “input” at the time of learning the linear regression equation based on the learning data. The learning unit 3 may select an attribute to be included as an explanatory variable in the linear regression equation by means of a feature selection algorithm such as Lasso regression and Forward-Backward (FOBA) Greedy.

The explanatory variables included in rₖ (Equation (2)) represent values for the attributes on the prediction target day obtained one day before the prediction target day. For example, X₁ in Equation (2) is an explanatory variable representing a forecast value for whether or not it is rainy on the prediction target day obtained one day before the prediction target day. Also, for example, X₂ in Equation (2) is an explanatory variable representing a value for whether or not an event is held on the prediction target day obtained one day before the prediction target day.

Also, the third tabular data (refer to FIG. 4) includes the value for the state (the number of reservations) on each of the days from the day one day before the day provided at the left end of the row to the day n days before the day provided at the left end of the row. The linear regression equation obtained by learning (linear regression equation obtained in the form of Equation (1)) may include an explanatory variable representing the number of reservations made one day before the prediction target day, an explanatory variable representing the number of reservations made two days before the prediction target day, . . . , and an explanatory variable representing the number of reservations made m days before the prediction target day. As described above, m is an integer of 1 or more and n or less.

In a case of m=1, the linear regression equation is expressed as Equation (1a) provided below.

yₖ₊₁=a₁yₖ+buₖ+rₖ (1a)

Also, in a case of m=2, the linear regression equation is expressed as Equation (1b) provided below.

yₖ₊₁=a₁yₖ+a₂yₖ₋₁+buₖ+rₖ (1b)

Also, in a case of m=n, the linear regression equation is expressed as Equation (1n) provided below.

yₖ₊₁=a₁yₖ+a₂yₖ₋₁+ . . . +aₙyₖ₋ₙ₊₁+buₖ+rₖ (1n)

The learning unit 3 may learn the linear regression equation for each of the cases from m=1 to m=n and determine a linear regression equation with the highest prediction accuracy among the obtained linear regression equations as a learning result. The learning unit 3 may learn the linear regression equation for each of the cases from m=1 to m=n and perform processing of deriving the prediction accuracy of each linear regression equation by means of cross validation. Specifically, the learning unit 3 classifies the first tabular data and the third tabular data into data for use in learning and data for use in validation of the prediction accuracy. For example, the learning unit 3 classifies the first tabular data and the third tabular data into data before “Jul. 16, 2017” and data after “Jul. 16, 2017” and learns the linear regression equation for each of the cases from m=1 to m=n with use of the data before “Jul. 16, 2017”. The learning unit 3 may then derive the prediction accuracy of each linear regression equation from the data after “Jul. 16, 2017” and determine a linear regression equation having the highest prediction accuracy as a learning result. Meanwhile, at the time of classifying the first tabular data and the third tabular data into data for use in learning and data for use in validation of the prediction accuracy, the data classification is performed using a common day as a standard in the first tabular data and the third tabular data.

The conversion unit 4 converts the linear regression equation learned in the form of Equation (1) to have a form of the state space model. Specifically, the conversion unit 4 converts the linear regression equation expressed in the form of Equation (1) into the state space model expressed in the form of Equation (3) provided below.

$$\begin{matrix} [ Mathematical 1 ] & \\ [ \begin{matrix}{y}_{k + 1} \\ {y}_{k} \\ {y}_{k - 1} \\ {y}_{k - m + 2}\end{matrix} ] = [ \begin{matrix}{a}_{1} & {a}_{2} & … & {a}_{m - 1} & {a}_{m} \\ 1 & 0 & 0 & … & 0 \\ 0 & 1 & 0 & … & 0 \\ ⋮ & & ⋱ & & ⋮ \\ 0 & 0 & ⋮ & 1 & 0\end{matrix} ] [ \begin{matrix}{y}_{k} \\ {y}_{k - 1} \\ {y}_{k - 2} \\ {y}_{k - m + 1}\end{matrix} ] + [ \begin{matrix}b \\ 0 \\ 0 \\ ⋮ \\ 0\end{matrix} ] {u}_{k} + [ \begin{matrix}{r}_{k} \\ 0 \\ 0 \\ ⋮ \\ 0\end{matrix} ] & ( 3 )\end{matrix}$$

The second row to the last row of Equation (3) expressed using a matrix express yₖ=yₖ, yₖ₋₁=yₖ₋₁, . . . , and yₖ₋ₘ₊₂=yₖ₋ₘ₊₂ in a matrix form.

The linear regression equation as in Equation (1) including the explanatory variables (yₖ, yₖ₋₁, . . . , and yₖ₋ₘ₊₁) each representing the state on each of the days from the day one day before the prediction target day to the day m days before the prediction target day and the explanatory variable (uₖ) representing the input on the prediction target day determined one day before the prediction target day can always be converted into the state space model expressed in the form of Equation (3). The state space model expressed in the form of Equation (3) is in a controllable canonical form and always has controllability.

The output unit 5 transmits the state space model derived in the form of Equation (3) to a prediction device (not illustrated) that predicts a value for the state yₖ₊₁ on the prediction target day, for example, via a communication network.

The output unit 5 is executed by, for example, a central processing unit (CPU) of a computer that operates in accordance with a state space model deriving program and a communication interface of the computer. For example, the CPU may read the state space model deriving program from a program recording medium such as a program storage unit of the computer and operate as the output unit 5 using the communication interface in accordance with the state space model deriving program. The data input unit 2, the learning unit 3, and the conversion unit 4 are also executed by, for example, the above computer that operates in accordance with the state space model deriving program. That is, the CPU that has read the state space model deriving program as described above may operate as the data input unit 2, the learning unit 3, and the conversion unit 4. Also, the data input unit 2, the learning unit 3, the conversion unit 4, and the output unit 5 may be executed by separate pieces of hardware.

Further, the state space model deriving system 1 may have a configuration in which two or more physically separated devices are connected by wire or wirelessly.

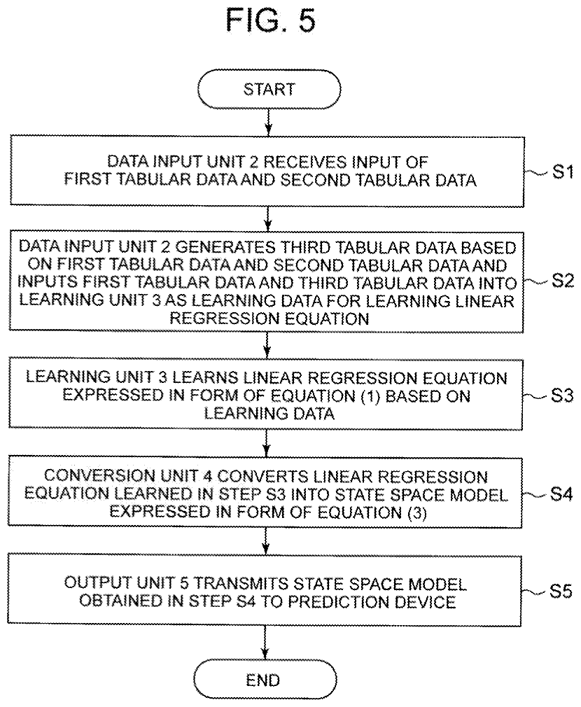

Next, a processing procedure of the state space model deriving system 1 will be described. FIG. 5 depicts a flowchart illustrating an example of a processing procedure of the state space model deriving system 1. Note that detailed description of the matters described above is omitted.

First, the data input unit 2 receives input of the first tabular data and the second tabular data (step S1).

The data input unit 2 then generates the third tabular data based on the first tabular data and the second tabular data and inputs the first tabular data and the third tabular data into the learning unit 3 as learning data for learning a linear regression equation (step S2).

The learning unit 3 learns the linear regression equation expressed in the form of Equation (1) based on the learning data (the first tabular data and the third tabular data) (step S3). Specifically, the learning unit 3 determines the coefficients of the respective explanatory variables (including the explanatory variables included in rₖ expressed in Equation (2)) on the right side of Equation (1) and the constant term included in rₖ by means of machine learning.

Also, at the time of learning the linear regression equation, the learning unit 3 learns the linear regression equation for each of the cases from m=1 to m=n and determines a linear regression equation with the highest prediction accuracy among the obtained linear regression equations as a learning result as described above. The learning unit 3 inputs the linear regression equation determined as the learning result into the conversion unit 4.

Subsequently, the conversion unit 4 converts the linear regression equation obtained in step S3 (the linear regression equation determined as the learning result) into a state space model expressed in the form of Equation (3) (step S4).

Subsequently, the output unit 5 outputs (transmits) the state space model obtained in step S4 to the prediction device (not illustrated) that predicts a value for the state yₖ₊₁ on the prediction target day (step S5).

According to the present exemplary embodiment, the learning unit 3 learns the linear regression equation using the first tabular data and the third tabular data as the learning data. Here, as illustrated in FIG. 4, the third tabular data includes the value for the state (the number of reservations) on each of the days from the day one day before the day provided at the left end to the day n days before the day provided at the left end. Also, as illustrated in FIG. 4, the third tabular data includes the value for the input (price) on the day provided at the left end determined one day before the day provided at the left end. Therefore, the learning unit 3 can learn the linear regression equation expressed in the form of Equation (1). That is, the learning unit 3 can learn the linear regression equation including the explanatory variables (yₖ, yₖ₋₁, . . . , and yₖ₋ₘ₊₁) each representing the state on each of the days from the day one day before the prediction target day to the day m days before the prediction target day and the explanatory variable (uₖ) representing the input on the prediction target day determined one day before the prediction target day. As described above, the linear regression equation including the explanatory variables (yₖ, yₖ₋₁, . . . , and yₖ₋ₘ₊₁) each representing the state on each of the days from the day one day before the prediction target day to the day m days before the prediction target day and the explanatory variable (uₖ) representing the input on the prediction target day determined one day before the prediction target day can always be converted into the state space model expressed in the form of Equation (3). The state space model expressed in the form of Equation (3) always has controllability. Therefore, according to the present exemplary embodiment, a state space model having controllability can be derived.

The prediction device (not illustrated) that predicts a value for the state yₖ₊₁ on the prediction target day receives the state space model transmitted by the output unit 5 in step S5. The prediction target day is a day after a day corresponding to a current day. On the day corresponding to the current day, the values for the explanatory variables (yₖ, yₖ₋₁, . . . , and yₖ₋ₘ₊₁) each representing the state (number of reservations) on each of the days in the state space model (refer to Equation (3)) obtained according to the present invention are known. Also, the value for the explanatory variable uₖ representing the input (price) in the state space model is determined by an administrator of the prediction device (hereinbelow referred to as an administrator) on the day corresponding to the current day. Also, the values for the respective explanatory variables included in rₖ (refer to Equation (2)) are obtained on the day corresponding to the current day by a weather forecast or the like. The administrator inputs the values for the respective explanatory variables into the prediction device. The prediction device substitutes the values for the respective explanatory variables into the state space model expressed in the form of Equation (3) to calculate a predicted value for the state (number of reservations) yₖ₊₁ on the prediction target day. This state space model has controllability. Therefore, the administrator can control the predicted value (value of yₖ₊₁) for the state on the prediction target day by changing the value for the input uₖ in the state space model. In the present exemplary embodiment, by controlling the price on the prediction target day (the value to be substituted into uₖ) on a day one day before the prediction target day, the administrator can control the number of reservations on the prediction target day so that the number may be a value near a target value, which is less than an upper limit of the number of reservations for the accommodation facility A. The target value for the number of reservations may be set by the administrator.

In the above exemplary embodiment, a case in which “state” in the state space model is the number of reservations for the guest rooms for the accommodation facility and in which “input” in the state space model is a price for using the accommodation facility has been described as an example. “State” and “input” in the state space model are not limited to those in the above example. For example, “state” in the state space model derived by the state space model deriving system 1 may be the number of reservations for a vehicle (for example, a passenger aircraft), and “input” in the state space model may be a price for using the passenger aircraft.

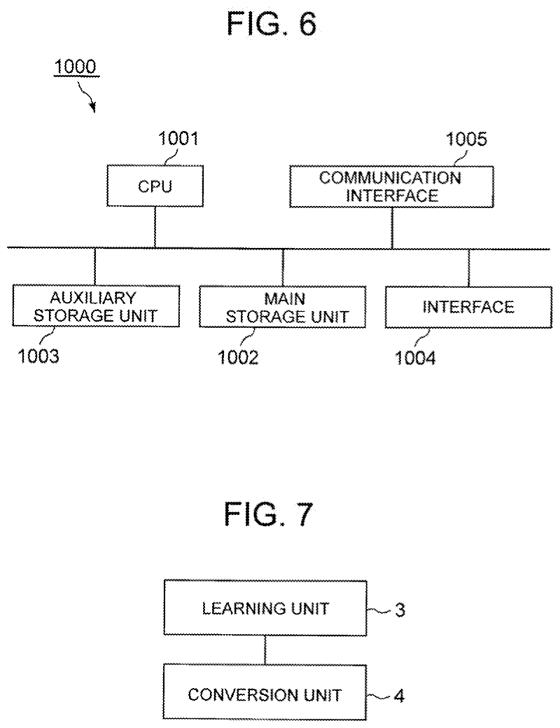

FIG. 6 depicts a schematic block diagram illustrating a configuration example of a computer according to the exemplary embodiment of the present invention. A computer 1000 includes a CPU 1001, a main storage unit 1002, an auxiliary storage unit 1003, an interface 1004, and a communication interface 1005.

The state space model deriving system 1 according to the exemplary embodiment of the present invention is implemented in the computer 1000. Operations of the state space model deriving system 1 are stored in the auxiliary storage unit 1003 in the form of the state space model deriving program. The CPU 1001 reads out the state space model deriving program from the auxiliary storage unit 1003, expands the program on the main storage unit 1002, and executes the above processing in accordance with the state space model deriving program.

The auxiliary storage unit 1003 is an example of a not-temporary tangible medium. Other examples of the not-temporary tangible medium are a magnetic disk, a magneto-optical disk, a compact disk read only memory (CD-ROM), a digital versatile disk read only memory (DVD-ROM), and a semiconductor memory connected via the interface 1004. Also, in a case in which the program is delivered to the computer 1000 via communication lines, the computer 1000 may receive the program, expand the program on the main storage unit 1002, and execute the above processing.

Also, the program may execute part of the above processing. Further, the program may be a difference program executing the above processing as a result of combination with another program prestored in the auxiliary storage unit 1003.

Also, a part or all of each component may be executed by general-purpose or dedicated circuitry, processor, or the like, or a combination thereof. The circuitry, processor, or the like, or the combination thereof may include a single chip or a plurality of chips connected via a bus. Also, a part or all of each component may be executed by a combination of the aforementioned circuitry or the like and a program.

In a case in which a part or all of each component is executed by a plurality of information processing devices, circuits, and the like, the plurality of information processing devices, circuits, and the like may be provided in a focused or distributed manner. For example, the information processing devices, circuits, and the like may be executed in a manner in which the respective units are connected via a communication network, such as a client-and-server system and a cloud computing system.

Next, an overview of the present invention will be described. FIG. 7 depicts a block diagram illustrating an overview of the state space model deriving system according to the present invention.

The state space model deriving system according to the present invention includes the learning unit 3 and the conversion unit 4.

The learning unit 3 learns a regression equation based on learning data.

The learning data includes a value (for example, the first tabular data) for a state (for example, the number of reservations for an accommodation facility) in a state space model at each time.

Also, the learning data includes a set (for example, the third tabular data) of combinations of a certain time (for example, a day provided at the left end of each row in the third tabular data illustrated in FIG. 4), a value for the state at each of times from a time one time before the certain time to a time n times (n is an integer of 2 or more) before the certain time, a value for an input (for example, a price) in the state space model at the certain time obtained one time before the certain time, and a value or values for one or more attributes (for example, “weather”, “humidity”, and “whether or not an event is held”) at the certain time obtained one time before the certain time.

The learning unit 3 learns a regression equation (for example, the linear regression equation expressed in the form of Equation (1)) using the state at a future time (for example, the prediction target day) as an objective variable and including, as explanatory variables, at least, explanatory variables (for example, yₖ, yₖ₋₁, . . . , and yₖ₋ₘ₊₁) each representing the state at each of times from a time one time before the future time to a time m times (m is an integer of 1 or more and n or less) before the future time and an explanatory variable (for example, uₖ) representing the input at the future time obtained one time before the future time.

The conversion unit 4 converts the regression equation to have a form of the state space model (for example, the state space model expressed in the form of Equation (3)).

With such a configuration, a state space model having controllability can be derived.

Also, the learning unit 3 may learn the regression equation including an explanatory variable or explanatory variables representing the value or values for the one or more attributes at the future time obtained one time before the future time.

Also, each day may be set as each time.

Further, the state in the state space model may be the number of reservations for a facility or a vehicle, and the input in the state space model may be a price for using the facility or the vehicle.

Although the present invention has been described above with reference to the exemplary embodiments, the present invention is not limited to the above exemplary embodiments. The configurations and the details of the present invention can be altered in various ways so as to be understandable by those skilled in the art within the scope of the present invention.

### INDUSTRIAL APPLICABILITY

The present invention is preferably applied to a state space model deriving system deriving a state space model based on learning data.

### REFERENCE SIGNS LIST

1 State space model deriving system
2 Data input unit
3 Learning unit
4 Conversion unit
5 Output unit

1. A state space model deriving system comprising:
a learning unit, based on
a value for a state in a state space model at each time, and
a set of combinations of a certain time, a value for the state at each of times from a time one time before the certain time to a time n times (n is an integer of 2 or more) before the certain time, a value for an input in the state space model at the certain time obtained one time before the certain time, and a value or values for one or more attributes at the certain time obtained one time before the certain time,
learning a regression equation using the state at a future time as an objective variable and including, as explanatory variables, at least, explanatory variables each representing the state at each of times from a time one time before the future time to a time m times (m is an integer of 1 or more and n or less) before the future time and an explanatory variable representing the input at the future time obtained one time before the future time; and
a conversion unit converting the regression equation to have a form of the state space model.

2. The state space model deriving system according to claim 1, wherein
the learning unit learns a regression equation including an explanatory variable or explanatory variables representing the value or values for the one or more attributes at the future time obtained one time before the future time.

3. The state space model deriving system according to claim 1, wherein
each day is set as each time.

4. The state space model deriving system according to claim 1, wherein
the state in the state space model is the number of reservations for a facility or a vehicle, and the input in the state space model is a price for using the facility or the vehicle.

5. A state space model deriving method comprising:
based on
a value for a state in a state space model at each time, and
a set of combinations of a certain time, a value for the state at each of times from a time one time before the certain time to a time n times (n is an integer of 2 or more) before the certain time, a value for an input in the state space model at the certain time obtained one time before the certain time, and a value or values for one or more attributes at the certain time obtained one time before the certain time,
learning a regression equation using the state at a future time as an objective variable and including, as explanatory variables, at least, explanatory variables each representing the state at each of times from a time one time before the future time to a time m times (m is an integer of 1 or more and n or less) before the future time and an explanatory variable representing the input at the future time obtained one time before the future time; and
converting the regression equation to have a form of the state space model.

6. The state space model deriving method according to claim 5, wherein
at time of learning the regression equation,
a regression equation including an explanatory variable or explanatory variables representing the value or values for the one or more attributes at the future time obtained one time before the future time is learned.

7. The state space model deriving method according to claim 5, wherein
each day is set as each time.

8. The state space model deriving method according to claim 5, wherein
the state in the state space model is the number of reservations for a facility or a vehicle, and the input in the state space model is a price for using the facility or the vehicle.

9. A non-transitory computer-readable recording medium in which a state space model deriving program is recorded, the state space model deriving program causing a computer to execute, based on
a value for a state in a state space model at each time, and
a set of combinations of a certain time, a value for the state at each of times from a time one time before the certain time to a time n times (n is an integer of 2 or more) before the certain time, a value for an input in the state space model at the certain time obtained one time before the certain time, and a value or values for one or more attributes at the certain time obtained one time before the certain time,
learning processing of learning a regression equation using the state at a future time as an objective variable and including, as explanatory variables, at least, explanatory variables each representing the state at each of times from a time one time before the future time to a time m times (m is an integer of 1 or more and n or less) before the future time and an explanatory variable representing the input at the future time obtained one time before the future time, and
conversion processing of converting the regression equation to have a form of the state space model.

10. The non-transitory computer-readable recording medium according to claim 9, wherein the state space model deriving program causes the computer to
learn, in the learning processing, a regression equation including an explanatory variable or explanatory variables representing the value or values for the one or more attributes at the future time obtained one time before the future time.
